(19) United States
(12) Patent Application Publication
(10) Pub. No.: US 2025/0251508 A1
(43) Pub. Date: Aug. 7, 2025

(54) Adaptive Frame Format Based on Mobility Scenario

(71) Applicant: Vestel Elektronik Sanayi ve Ticaret A. S., Manisa (TR)

(72) Inventors: Saira Rafique, Istanbul (TR); Hüseyin Arslan, Istanbul (TR)

(21) Appl. No.: 18/856,001

(22) PCT Filed: Apr. 11, 2022
(86) PCT No.: PCT/EP2022/059655

§ 371 Date: Oct. 10, 2024

(51) Int. Cl. G01S 13/76; H04B 1/69

(52) U.S. Cl. CPC G01S 13/765; H04B 1/69; H04B 2001/6912

(57) ABSTRACT

Some embodiments in the present disclosure relate to transmitting and/or receiving sensing signals. Based on an estimation of the mobility of a wireless device, a frame format is selected and transmitted. In a first mobility scenario (e.g., a high mobility scenario), a first frame is transmitted that includes a sensing signal having a first waveform. In a second mobility scenario (e.g., a low mobility scenario), a second frame is transmitted that includes a sensing signal having a second waveform.

### CROSS-REFERENCE TO RELATED APPLICATION

This application is the United States national phase of International Patent Application No. PCT/EP2022/059655 filed Apr. 11, 2022, the disclosure of which is hereby incorporated by reference in its entirety.

### BACKGROUND

### Field

The present disclosure relates to wireless sensing and joint sensing and communication transmissions. In some embodiments, the present disclosure provides methods and apparatuses for such wireless applications.

Technical Considerations Wireless communication has been advancing over several decades now. Exemplary notable standards organizations include the 3rd Generation Partnership Project (3GPP) and IEEE 802.11, commonly referred to as Wi-Fi.

Cognitive radio is one of the emerging technologies for exploiting the system spectrum. Cognitive radio devices are supposed to dynamically use the best wireless channels in their vicinity to improve spectrum efficiency. In order to achieve this, spectrum occupancy information may be desirable to help modeling and predicting the spectrum availability for efficient dynamic spectrum access. Spectrum occupancy prediction may be based on using the information on previous spectrum occupancy to predict future occupancy. Such a prediction is based on exploiting the inherent correlation between past and future occupancies. Some approaches exploit time-domain correlation and thus cast spectrum prediction as a time-series prediction. Some approaches additionally consider exploiting the correlation along the frequency axis, and thus exploit time-frequency correlation. Correlation may also exist in the spatial domain. Thus, exploiting the correlation in all mentioned domains may be desirable.

Future wireless devices are expected to be sensing capable, or at times, solely wireless sensors, to support communication applications and/or provide a wide range of other applications, such as fully immersive extended reality, improving quality of life by enabling smart environments, improving health-related applications through non-invasive tests and vital signs monitoring.

### SUMMARY

The present disclosure relates to methods and apparatuses for an adaptive frame design based on a mobility scenario.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification. It is to be expressly understood, however, that the drawings are for the purpose of illustration and description only and are not intended as a definition of the limits of the disclosed subject matter. As used in the specification and the claims, the singular form of “a,” “an,” and “the” comprise plural referents unless the context clearly dictates otherwise.

### BRIEF DESCRIPTION OF THE DRAWINGS

The terms Fig., Figs., Figure, and Figures are used interchangeably in the specification to refer to the corresponding figures in the drawings.

An understanding of the nature and advantages of various embodiments may be realized by reference to the following figures.

FIG. 1 is a block diagram illustrating a basic communication system;

FIG. 2 is a block diagram illustrating a scheduling device with a plurality of wireless devices of various types;

FIG. 3 is a schematic drawing illustrating various frame format depending on whether the application generating the frame is sensing, communication of JSC;

FIG. 4a is a schematic drawing illustrating a simple sensing scenarios in absence of objects to be detected;

FIG. 4b is a schematic drawing illustrating a simple sensing scenarios in presence of objects to be detected;

FIG. 5a is a schematic drawing illustrating a sensing scenario with multiple devices communicating and sensing via line of sight;

FIG. 5b is a schematic drawing illustrating a sensing scenario with multiple devices communicating and sensing via non line of sight;

FIG. 6a is a schematic drawing illustrating the training phase of a machine learning model;

FIG. 6b is a schematic drawing illustrating the testing phase of a machine learning model;

FIG. 7a shows an exemplary waveform of a linear chirp;

FIG. 7b shows an exemplary waveform of a hyperbolic chirp;

FIG. 8 illustrates exemplarily a transmitted and a reflected linear chirp signal;

FIG. 9 is a block diagram illustrating a transmitting device and a receiving device;

FIG. 10 is a schematic drawing illustrating different mobility scenarios;

FIG. 11 is a schematic drawing illustrating a selection of a frame format for different mobility scenarios;

FIG. 12 is an exemplary flowchart for the transmitting of a sensing signal including an adaptive frame format;

FIG. 13 is an exemplary flowchart for the receiving of a sensing signal including an adaptive frame format;

FIG. 14 illustrates exemplarily a first and a second frame format;

FIG. 15a is a block diagram illustrating an exemplary apparatus for sensing signal sharing;

FIG. 15b is a block diagram illustrating an exemplary memory for an apparatus transmitting a sensing signal;

FIG. 15c is a block diagram illustrating an exemplary memory for an apparatus receiving a sensing signal.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to comprise one or more items and may be used interchangeably with “one or more” and “at least one.” Furthermore, as used herein, the term “set” is intended to comprise one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Although the aforementioned techniques may be successful in some cases, they do not provide full information or awareness about the future spectrum or its usage. Meanwhile, wireless sensing is gaining popularity in commercial devices, for environment monitoring, health monitoring, and numerous other applications. Military use of wireless sensing such as radar has always been popular. Sensing applications generate signals, which may typically have a pattern different from those of some communication applications. For instance, most wireless sensing applications generate periodic signal transmissions of varying periodicity. However, not every signal is suitable for each scenario. Effectively adapting a frame format including sensing signals may result in less spectrum and power wastage.

FIG. 1 illustrates an exemplary wireless system WiS in which Tx represents a transmitter and Rx represents a receiver of the wireless signal. The transmitter Tx is capable of transmitting a signal to the receiver Rx or to a group of receivers or to broadcast a signal over an interface Itf. The interface may be any wireless interface. The interface may be specified by means of resources, which can be used for the transmission and reception by the transmitter Tx and the receiver Rx. Such resources may be defined in one or more (or all) of the time domain, frequency domain, code domain, and space domain. It is noted that in general, the “transmitter” and “receiver” may be also both integrated into the same device. In other words, the devices Tx and Rx in FIG. 1 may respectively also comprise the functionality of the Rx and Tx.

The present disclosure is not limited to any particular transmitter Tx, receiver Rx and/or interface Itf implementation. However, it may be applied readily to some existing communication systems as well as to the extensions of such systems, or to new communication systems. Exemplary existing communication systems may be, for instance the 5G New Radio (NR) in its current or future releases, and/or the IEEE 802.11 based systems such as the recently studied IEEE 802.11 be or the like. The wireless signal is not necessarily a communication signal in the sense that it does not necessarily carry out human or machine communication. It may be, in some embodiments, a sensing signal such as a radar signal or sounding a signal or any other kind of wireless signal from a sensing device such as some signal reporting sensing results to another device(s).

For instance, the amendment IEEE 802.11bf—Wireless Local Area Network (WLAN) Sensing—may comprise support for wireless sensing in WLAN networks. Some embodiments may be used to enhance the performance of devices complying with this standard, e.g., to reduce the amount of redundant sensing signals in an area or a network. The fifth-generation (5G) New Radio (NR) standard, 6G standards or other future standards may also apply wireless sensing as its part of future cellular communications networks. Some embodiments of the present disclosure may help to predict the empty spaces in the licensed-exempt spectrum during opportunistic spectrum usage, where most wireless sensing is expected to take place. The present disclosure is also applicable to other communication technologies such as 3G or communication technologies under long-term evolution (LTE)/LTE Unlicensed (LTE-U).

As mentioned above, spectrum awareness is a part of cognitive radio (CR). Some embodiments of the present disclosure may facilitate the identification and prediction of sensing transmissions. The IEEE 802.22 and IEEE 802.15 standard support CR and may thus profit from the present disclosure. The present disclosure is also applicable to low-power wide-area network (LPWAN) technologies, as it aids in increasing power efficiency through reducing the number of redundant sensing transmissions. Thus, it is related to LPWAN standards such as Wize, ZigBee, NarrowBand IoT, and LoRaWAN. In general, some embodiments can be used in high frequencies or millimeter waves (mm-waves)—as the spectrum availability and propagation characteristics are suitable for high-resolution wireless sensing. It can be used for managing resources for wireless sensing.

There may be separate devices comprising the functionality of the Rx and Tx, respectively. The transmitter Tx and receiver Rx may be implemented in any device such as a base station (eNB, AP) or terminal (UE, STA), or in any other entity of the wireless system WiS. A device such as a base station, access point, or terminal may implement both Rx and Tx. The present disclosure is not limited to any particular transmitter Tx, receiver Rx and/or interface Itf implementation. However, it may be applied readily to some existing communication systems as well as to the extensions of such systems, or to new communication systems. Exemplary existing communication systems may be, for instance, the 5G New Radio (NR) in its current or future releases, and/or the IEEE 802.11 based systems such as the recently studied IEEE 802.11 be or the like. Sensing applications signals may also be embedded within resources provided by one or more or the known systems such as some IEEE 802.11 standards or their possible specific extensions for supporting sensing applications.

Future wireless devices are expected to be sensing capable, or at times, solely wireless sensors, to support communication applications and/or provide a wide range of other applications, such as fully immersive extended reality, improving quality of life by enabling smart environments, improving health-related applications through non-invasive tests and vital signs monitoring, and much more. Wireless sensing applications may require periodic or continuous sensing transmissions. However, allowing all sensing/sensing capable devices to transmit their own sensing transmissions may reduce spectral efficiency and degrade the performance of networks operating in the license-exempt bands. Additionally, because sensing transmissions are periodic, there is a strong likelihood that they will cause interference to communication transmissions if they are scheduled opportunistically, or if they have opportunistic channel access mechanisms. This problem can be solved by including sensing-aware channel access and sensing coordination protocols in the standards. However, these would only enable communication and coordination for sensing and devices within the same network. At the same time, this would increase control signalization overhead and complexity. Wireless communication trends are heading towards decentralized and minimum-coordination networks, with the coexistence of a larger number of wireless networks in the same area. As such, methods to identify and predict, or the act of identifying and predicting, future sensing transmissions before transmitting are required in the standards. This would allow devices to better allocate their resources and schedule their transmissions.

Wireless sensing is a process of obtaining information or awareness of the environment through measurements on received (e.g., reflected or directly received) electromagnetic signals. In this embodiment, processes such as spectrum/channel sensing, radar, joint radar and communication, WLAN sensing, and other methods can be considered as wireless sensing methods. Most wireless sensing methods have either periodic or continuous transmission patterns. An example could be a radar, where a continuous signal or periodic pulses are transmitted. Another example could be channel state information (CSI) based WLAN sensing, where packets are transmitted with some periodicity.

For example, signal characteristics for radar-based sensing may comprise periodicity, bandwidth, frequency, number of antennas and/or training sequences. In the CSI-based sensing, signal characteristics may comprise, for example, periodicity, bandwidth, frequency and/or number of antennas.

The sensing transmissions may have a specific frame design or transmission mechanism, which is specific for some sensing application(s) and may vary based on the sensing application requirements and environment conditions. Periodicity may be a useful condition for sensing applications, as disruptions in the periodicity of transmitted/received signals due to interference from other devices, the inability to schedule transmissions, or access the channel using channel access protocols may cause a disruption of measurements. This may cause false alarms, missed detections, reduced resolution of sensed information, overall performance degradation of the sensing application. Depending on the application, this could have severe monetary consequences or life risks.

Signal identification allows devices to identify some features of a signal, such as wireless technology (LTE, 5G, etc.), waveform, modulation type, etc., based on some characteristics of the signals, such as bandwidth, spectrogram image, etc. There are some applications in which certain characteristics are identified for the purpose of synchronization or authentication. Also, spectrum sensing is known, which is used to identify primary users' spectrum occupancy status. However, it may require continuous spectrum sensing. Alternatively, spectrum prediction techniques can be used to save time, energy, and computation overheads required by spectrum sensing.

In future wireless communications, there may be several wireless sensing applications. Generally, sensing applications use continuous signals (with some periodicity), which may degrade the spectral efficiency drastically. This is especially the case where numerous sensing applications/devices are used at the same time and/or in the same area.

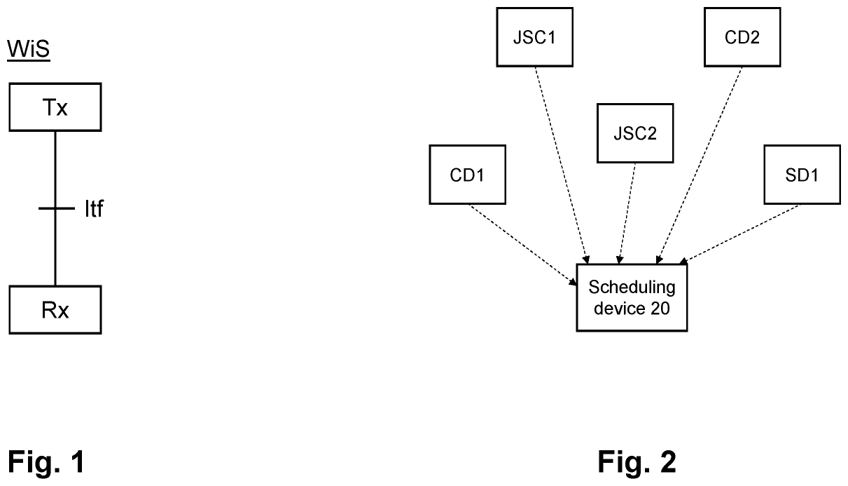

Scheduling of transmissions may be performed by a scheduling device 20, as shown in FIG. 2. The scheduling device 20 may receive a request for scheduling a transmission of a signal by a wireless device. The wireless device may be a communication device, a sensing device, or a joint sensing and communication (JSC) device. FIG. 2 shows a plurality of various devices to request resources for signal transmission from the scheduling device 20. In some embodiments, the plurality of devices comprises communication devices CD1 and CD2, JSC devices JSC1 and JSC2, as well as a sensing device SD1. In general, a communication device is a device configured to run an application, which makes use of wireless communication, such as a communication according to a wireless standard.

Sensing devices have wireless sensing functionality. They are configured to run a sensing application. These devices may be also configurable or configured to perform wireless communication to transmit their sensed measurements, which is typically a small amount of data compared to amounts of data transmitted by usual communication applications or devices. In the sensing, measurements are taken as the parameters (features) which can be extracted from the wireless signal received, whether directly or after some processing. Some non-limiting examples of measured parameters comprise received signal strength indicator (RSSI), channel state information (CSI), range, velocity, and/or the like.

JSC devices are configured to run both the communication application(s) and the sensing application(s). For example, the main function of the JSC devices may be communication, meaning they may have a large amount of data to transmit, but they can perform wireless sensing as well, to improve communication performance or for a user application, such as navigation, or the like. For example, the main function of the JSC devices may be sensing, but they can perform communication as well. In some examples, the functions of sensing and communication may be equal.

Some non-limiting examples of sensing devices comprise smart bands, non-invasive medical sensors, such as heart rate monitors, body mass monitors, and/or the like. Non-limiting examples of applications supported (implemented) by JSC devices comprise object tracking and/or user tracking for beam management, physical layer security through physical user (human) identification, or the like. Non-limiting exemplary devices comprise cellphones, laptops, tablets, access points (APs), and/or the like.

### Wireless Sensing Applications and Characteristics

A sensing session may be comprised of one or more of the following phases: setup phase, measurement phase, reporting phase, and/or termination phase. In the setup phase of a sensing session, a sensing session is established, and operational parameters associated with the sensing session are determined and may be exchanged between STAs. In the measurement phase of a sensing session, sensing measurements are performed. In the reporting phase of a sensing session, sensing measurement results are reported. In the termination phase of a sensing session, STAs stop performing measurements and terminate the sensing session.

When more than one independent device is involved in the sensing process (i.e., collaborative wireless sensing), sensing may be performed after some planning by the involved devices. An initiating station (ISTA) is the device which may initiate the wireless sensing process, generally by requesting some resources (transmissions, and/or measurements, etc.) from other devices. A responding station (RSTA) may respond to the ISTA by transmitting sensing transmissions and/or making measurements on sensing signals transmitted by other RSTA and/or making spectrum measurements. These measurements may be communicated to the ISTA or some processor (which in turn will communicate the results of the sensing to the ISTA or sensing requesting application associated with the ISTA).

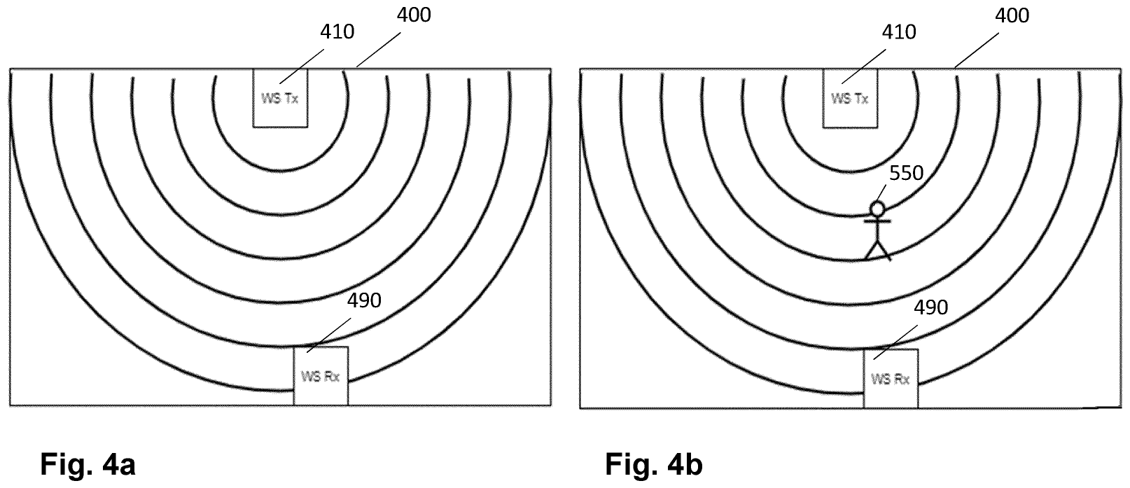

FIGS. 4a and 4b show an illustration of a generic sensing application. Here, wireless sensor (WS) transmitter (Tx) 410 is the wireless sensor transmitter and WS receiver (Rx) 490 is the wireless sensor receiver. The WS Tx and WS Rx are synchronized, and may coordinate with each other, either through wireless signalization or via a wired connection. The WS Tx 410 and the WS Rx 490 are located in a limited area, such as a room 400. The concentric circle portions illustrate the electromagnetic field (wireless sensing signal) generated by the WS Tx 410. As can be seen in the figure, the WS Rx 490 is in the range of the wireless sensing signal. As discussed above, the wireless sensing signal may be a sensing pulse or continuous signal such as radar or a sounding signal. However, it may be also reporting of a regular measurement in a packet form or the like.

FIG. 4a is only an example configuration of wireless sensing hardware. Other configurations could comprise more than one transmitters and/or more than one receivers, and/or one or more transceivers, etc. Here, the term transceiver denotes a receiver or a transmitter or a combination of both. Initially, the WS Tx 410 may transmit the sensing signals when there is nothing to be detected (there is no object in the monitored object size range), as shown in FIG. 4a. The WS Rx 490 receives these sensing signals and takes measurements, for example, CSI or any signal strength indicating measurements. Then, when there is something to be detected, which is shown as a stick man 450 in FIG. 4b, the changes in the measurement indicates that there is something to be detected. In other words, the presence of the object 450 changes the channel and thus, the received signal, which can be detected at WS Rx 490. It is noted that this is only an example in which there are cooperating transmitter and receiver WS. However, the present disclosure is not limited thereto and instead of detecting signal transmitted from a certain transmitter located in a position different from the position of the receiver, some sensing applications may rely on a transceiver including co-located transmitter and receiver, such as a pulse radar in which case the signal detected is a signal reflected from the detected object.

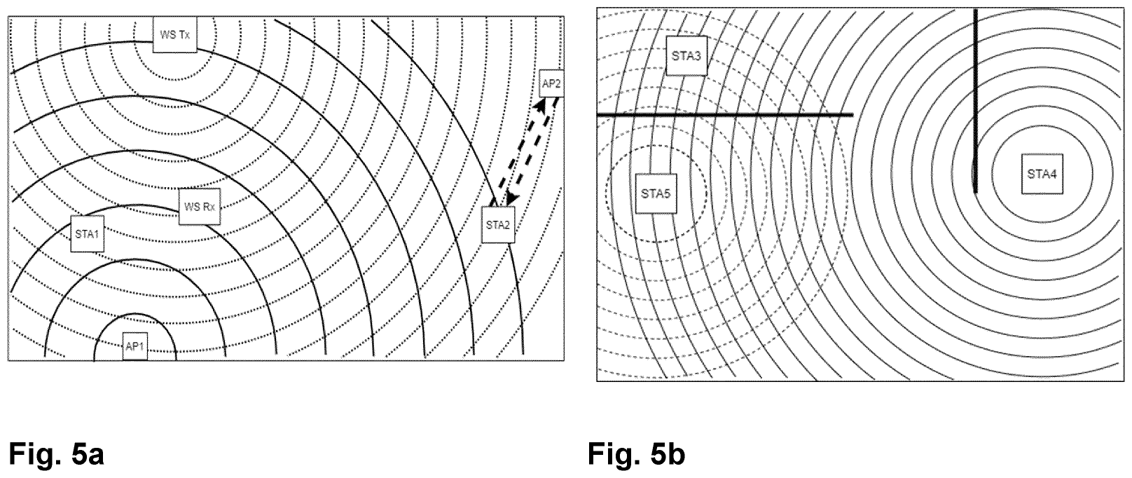

FIGS. 5a and 5b show further different exemplary sensing scenarios. The different devices performing sensing and communication in the region can be solely sensing devices, shown as WS Tx and WS Rx. Alternatively, or in addition, the sensing may be performed between Aps (or other network controllers/coordinators) and stations (STA)s, or between STAs and other STAs. At the same time, other network devices can be communicating. The sensing devices may be line of sight (LOS), as shown in FIG. 5, or non-line of sight (nLOS), as shown in FIG. 5b. For example, in FIG. 5, a WS Tx transmits a first sensing signal (dotted line). An AP1 transmits another sensing signal (solid line). STA1 may receive the sensing signal from the AP1 whereas WS Rx may receive the sensing signal from the WS Tx. However, the STA1 may also use the sensing signal from WS Tx and the WS Rx may also receive the sensing signal from the AP1 in some scenarios. Here, by receiving, what is meant is detecting as present and possibly processing further, i.e., not merely receiving as a part of noise. Moreover, AP2 and STA2 are in communication with each other, i.e., exchange communication signal. All these devices are in LoS in this simplified example. Some or all of these devices may operate in the same or at least partially overlapping spectrum.

As shown in the figures, the sensing signals may have different periodicity (indicated by different density of the concentric circle portions illustrating the sensing signal). In this case, identifying the sensing applications without direct communication or coordination with another wireless device may be beneficial. In response to the detection of a sensing signal, the devices can use signals, which are suitable for them rather than transmitting their own sensing signals. For example, once the STA1 detects that WS Tx is transmitting a sensing signal, it may use the sensing signal in addition or alternatively to the sensing signal from the AP1. It is even possible that AP1 detects sensing signal from WS Tx and stops transmitting its own sensing signal, since one sensing signal may be sufficient. Or, vice versa, WS Tx detects that AP1 transmits a sensing signal and stops its own transmission of the sensing signal. As is clear to those skilled in the art, various implementations of coordination and adaption of the sensing environment may be provided once the sensing applications (signals from sensing applications) have been detected in an area.

FIG. 5b shows a scenario in which there is not necessarily a LoS between some or all of the devices. In the figure, in fact none of the devices STA3, STA4, and STA5 present in the sensing area has a LoS to the other devices. Nevertheless, still, sensing signals may be received at the sensing signal receiving devices. E.g., STA5 has no LoS to STA3 and STA4, but may still receive their sensing signal. Thus, STA5 may decide to switch off its own signal and use the sensing signal of STA4 or STA3 or the like. Using the sensing application identification and prediction technique discussed above, devices can learn which sensing application the signals are for, predict their duration and future spectrum usage and either schedule their own signals such that there is no interference (resource allocation) or utilize these signals for their own sensing application.

In the above description, some particular examples were given. However, the present disclosure is not limited to those examples. Rather, variations and modifications may be advantageous for some scenarios. For example, any features that are different for sensing and communication signals can be used to differentiate them, such as frame structure, periodicity, resolution, RSS/RSSI values, or some features of the sensing that will be defined in the future standards, such as periodic channel access mechanisms, back-off behavior, special sensing sequences or waveforms, and/or the like. The RSS/RSSI can be used instead of PSD for detecting spectrum occupancy and/or for measurement of the signal to determine whether it is a communication or a sensing signal or to determine the sensing application, which originated said signal. For example, the RSS/RSSI measurement is available effortlessly in most communication devices and can give a rough quantification of user activity, i.e., spectrum usage. The term “user” here refers more broadly to a particular application running on a device.

Some embodiments of the present disclosure may be used for applications such as home surveillance or home appliances or entertainment.

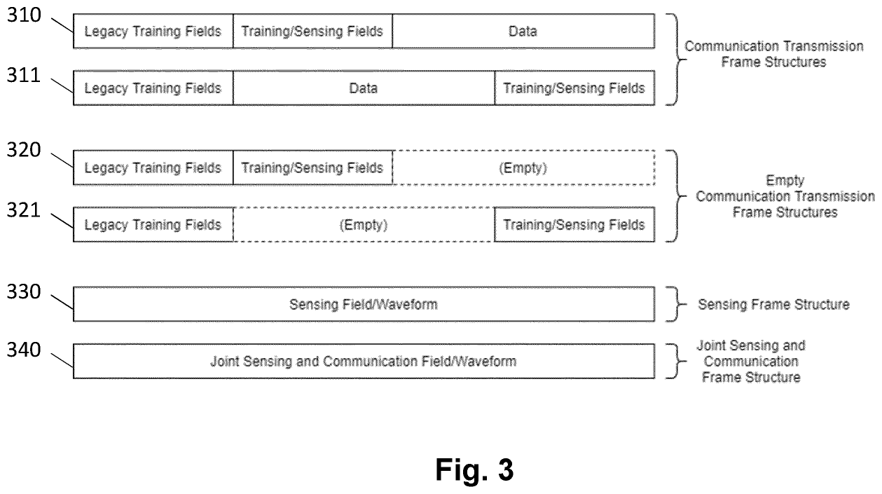

Different sensing applications may require different characteristics of the sensing signal. Some characteristics of the signal are, for example, bandwidth (BW), sensing duration, sensing start time, sensing end time, waveform, periodicity, carrier frequency, power, beam width, beam sweep rate, training sequences, pilot placement, and/or the like. Exemplary frame structures such as communication transmission frame structures 310, 311, empty communication frame structures 320, 321, sensing frame structures 330 and joint sensing and communication frame structures 340 are shown in FIG. 3.

There may be numerous communicating devices in all frequency bands. To summarize, the sensing elements and example parameters for an exemplary scenario may be as listed below:

### (Mobile) Autonomous Vehicles:

Single transceiver
Frequency-Modulated Continuous Wave (FMCW) radar waveform
Frequency=6 GHz
Bandwidth (BW)=40 MHz
Periodicity=100 pkts/s

### (Stationary) Roadside Unit:

Single transceiver
FMCW radar waveform
Frequency=60 GHz
BW=1 GHz
Periodicity=100 pkts/s

### Home Monitoring:

2 APs and 5 sensing/responding nodes
Wi-Fi Physical-layer Protocol Data Unit (PPDU) frame format
Frequency=2.4 GHz
BW=20 MHz
Periodicity=100 pkts/s

### Sleep Monitoring

1 transmitter and 1 receiver
Wi-Fi PPDU
Frequency=60 GHz
BW=20 MHz
Periodicity=10 pkts/s

### Gesture Recognition

1 APs and 5 sensing/responding nodes
FMCW radar waveform
Frequency=60 GHz
BW=120 MHz
Periodicity=100 pkts/s

As can be seen in the above-mentioned examples, there are one or more features, which enable distinction between the applications. It is noted that the above example is fictional, and that the measurement values may vary. It is noted that these five features (number of transmitters and/or receivers, frame structure/waveform, carrier frequency, bandwidth, and periodicity) are only exemplary here. In general, depending on the desired resolution for the sensing application identification, one or more of these five features and/or any other feature capable of distinguishing (or contributing to the distinction) between sensing applications may be used. In exemplary and non-limiting implementations, the features may be required as mentioned above.

### Identification of Sensing Signals

Signal characteristics and or sensing applications may be identified based on (blind signal analysis) BSA techniques and/or using predefined tags and/or a set of rules or the like.

Features of a signal out of the existing sensing signals may be identified by machine learning (ML) algorithms.

The ML-based approach may comprise two stages, which are referred to as training and testing. In the training stage, a dataset may be collected, and the ML model may be configured and trained. Then, in the testing stage, the features of existing sensing signals may be learned. These stages are detailed below.

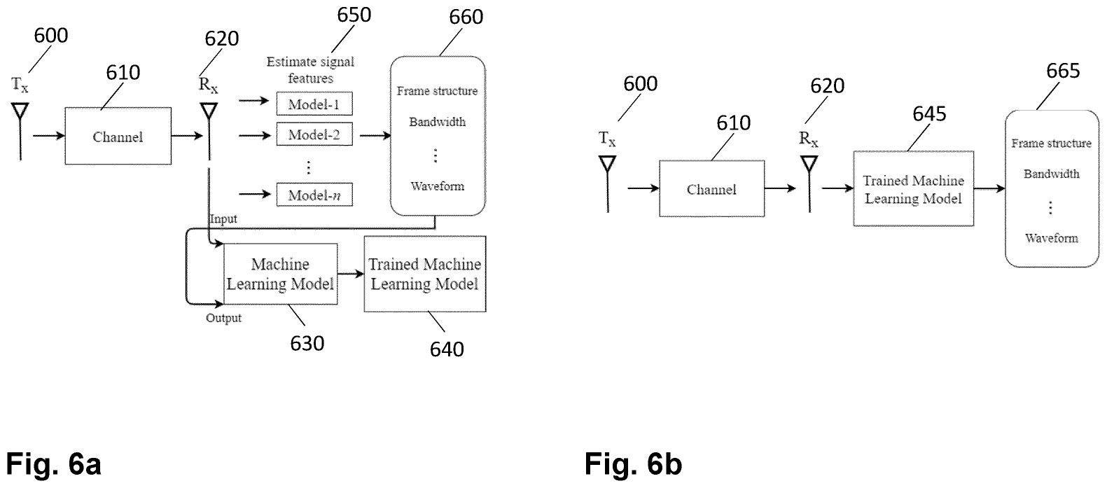

In the training stage, a set of signals may be transmitted by a transmitter 600 via a wireless communication channel 610 and received signals may be captured at the receiver 620. Afterwards, signal features of the received signals, may be estimated by conventional algorithms (models) 650. Then, these estimated features may be stored as outputs in vector format. Correspondingly, the received signals of which these features may be obtained are stored as the input. These processes may be repeated until a sufficient dataset may be generated. The size of the dataset may be determined according to the system requirements, for example, in terms of system performance, complexity, and memory. Then, the ML model 630 may be trained with the created dataset in order to obtain a trained machine learning model 640. These processes are illustrated exemplarily in FIG. 6a. Here note that all hyperparameters of the ML algorithm may be tuned empirically by considering the performance and generalization capability of the algorithm. Once the training and validation loss convergence (using training and validation data) is done in the training stage, the testing stage may start, which characterizes the run-time operation of the algorithm.

In the testing stage, a signal is captured in the receiver 620. Then, this signal is fed to the trained ML algorithm 645. Afterward, the trained ML algorithm estimates the signal features 665. These processes are illustrated exemplarily in FIG. 6b.

It is noted that the transmission over the channel 610 may be simulated. In such simulation, the channel may be represented by a certain mathematical model, or obtained by simulating actual transmission conditions. In these simulations since the features of the transmitted signals are known, there will be no need to estimate features by conventional algorithms in the training stage. The provision of data from the real system, however, may help training the ML model more efficiently for practical use.

For example, instead or in combination with the trained (e.g., ML/DL) module, other kinds of methods such as statistical methods or deterministic methods may be employed for the estimation. For example, if it is observed that a signal is repeating periodically, ML or DL methods may not be necessary to detect presence of such sensing signal. It can be determined deterministically whether sensing is taking place or not. In a blind signal analysis (BSA) a received signal may be analyzed regarding its characteristics such as frequency, bandwidth, periodicity and/or the like. A blind signal analysis may take into account, for example, time domain related features such as received signal strength indication, complementary cumulative distribution function (CCDF), peak to average power ratio (PAPR), duty cycle, and/or frame/burst length. A blind signal analysis may further take into account, for example, frequency domain related features such as bandwidth and/or carrier frequency. Further characteristics used in a BSA may be cyclostationarity-based features of the signal such as spectral correlation and/or cyclic features, statistical properties such as autocorrelation function properties, variance, mean, cumulants, and/or moments (2^{nd}, 3^{rd} etc.) and/or multi-carrier parameters of the signal in the time domain (cyclic prefix (CP) duration, and/or symbol duration) and/or the frequency domain (number of subcarriers, and/or subcarrier spacing). Characteristics used in BSA may further comprise chip rates, symbol rates, the angle of arrival, a distinction between single-carrier or multi-carrier, a distinction between spread spectrum or narrowband, a hopping sequence and/or a type of modulation and its order.

Similarly, for sensing application identification, given a predefined set of features and their values for particular applications, identification may be performed. Still further, where sensing applications use specific header information for detecting network types, this or other header information may be detected and used deterministically to determine the identification of an application. There may be the drawback of defining the parameters (features and their values) and application sets for each environment. Thus, depending on the deployment scenario, trained modules may provide better results, for example in more complex scenarios, where deterministic or stochastic distinction is difficult or complex.

Identification or prediction may be made with MAC Layer Protocols and/or PHY Layer (like with BSA methods), and/or using some tags (like coding). Identification or prediction may be made in Network Layer and/or even maybe in upper layers of the Open Systems Interconnection (OSI) model. Also, there may be no need to identify applications. Application identification may not be enough to understand signal characteristics since the environment characteristics may be changed and devices that receive the signal may be different. It may be impossible to have a complete list for all sensing applications. Thus, applications themselves or applications and environments may be grouped/classified based on their similarities, or requirements of the application may be determined by the request of the corresponding wireless system in the setup phase.

### Chirps as Sensing Signals

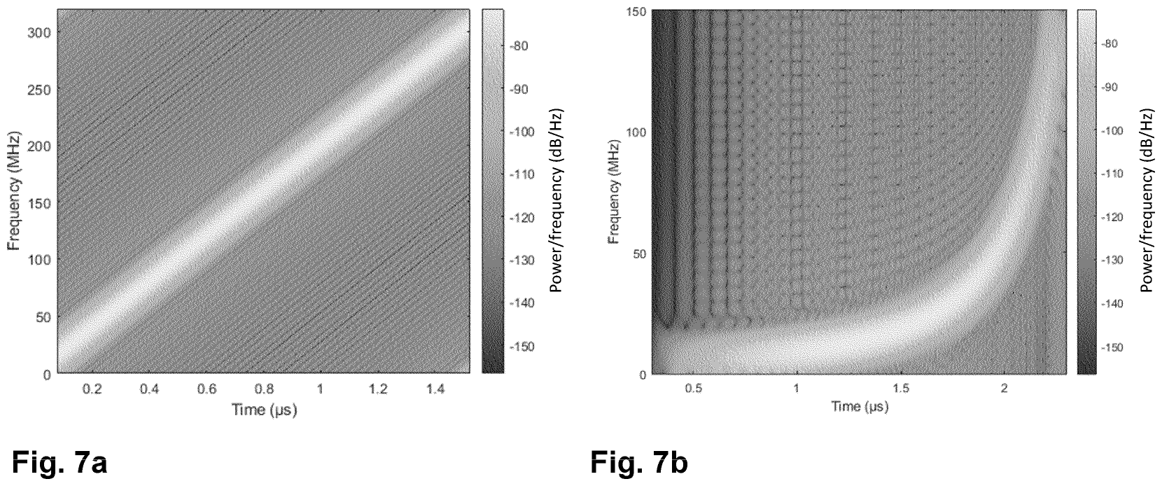

A chirp is a signal in which the frequency increases (up-chirp) or decreases (down-chirp) with time. For example, such a change in frequency may be linear or non-linear with time. The frequency-time relation of a linear frequency modulated (LFM) chirp is shown exemplarily in FIG. 7a. A non-linear frequency modulated (NL-FM) chirp comprises a change in frequency that is, for example, quadratic, exponential, logarithmic, hyperbolic or the like. An exemplary frequency-time relation of a hyperbolic frequency modulated (HFM) chirp is shown in FIG. 7b.

In a sensing signal, where only LFM chirps are employed for sensing there are certain limitations. For example, the LFM chirp signal undergoes the problem of range-Doppler coupling, which may yield displacement in the estimation of the range of a target from its actual position due to the relative velocity of the object. Such errors in the range calculation can lead to erroneous target tracking. Moreover, radar matched filter output of linear chirps typically yields high sidelobes, typically in an order of −13 db. Windowing is used to suppress these high sidelobes. However, windowing may degrade the signal-to-noise-ratio (SNR) by 1-2 db.

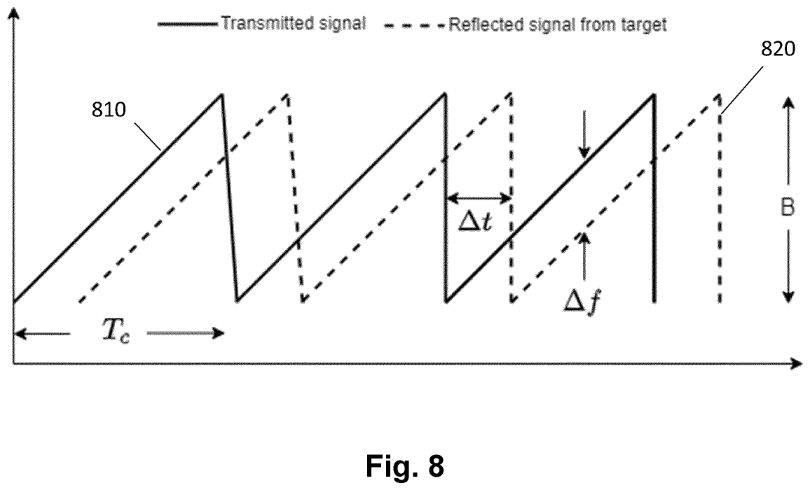

FIG. 8 demonstrates an exemplary time-frequency relation of a transmitted LFM chirp 810 and a received LFM chirp 820 that is reflected off the target. The time difference between the two chirps is denoted by Δt. Moreover, at a given time t, the difference in received and transmitted frequency is given by Δf, which is also called beat frequency and is given by f_{beat}=f_{received}−f_{transmitted}.

The beat frequency is related to time delay and rate of change of frequency and is used to determine the range of the target. In case of a moving target, Doppler shift is also added to the beat frequency in addition to the delay. Given that f_{beat}=BΔt/T_{c}, wherein B denotes the sweep frequency range of the chirp, the range of the object can be found as,

$$R = \frac{{cT}_{C} {f}_{beat}}{2 B} .$$

A range-Doppler processing of a LFM chirp comprises the process of dechirping where the received signal is mixed with the transmitted signal to get the beat signal. Afterwards, fast Fourier transform (FFT) is applied to the beat signal to obtain a range plot. Additionally, a two-dimensional fast Fourier transform (2D-FFT) can be applied to the beat frequency to obtain a range-velocity map.

Non-linear chirps usually occupy more space in the TF plane, i.e., they have a larger time bandwidth product than their linear counterpart and hence NL-FM chirps are resilient to a wide range of Doppler shifts. Moreover, the NL-FM chirps can reshape the PSD (power spectral density) so that the autocorrelation function has less sidelobes (lower than −35 dB) than a LFM chirp and therefore, no additional filtering is required for sidelobe suppression. Although non-linear chirps may offer significant performance gains over linear chirps, their generation and processing are more complex.

A sensing signal including a NL-FM chirp, such as for example, a quadratic chirp, an exponential chirp, a logarithmic chirp, a hyperbolic chirp or the like, facilitates a decoupled processing of range and velocity. A sensing signal including at least one non-linear chirp may be comprised in a frame. The frame may be a joint sensing and communication frame. For example, the sensing signal may be comprised in any of the sensing fields in the exemplary frame structures shown in FIG. 3, such as communication transmission frame structures 310, 311, empty communication frame structures 320, 321, sensing frame structures 330 and joint sensing and communication frame structures 340.

Such a frame structure comprising at least one non-linear chirp as sensing signal may be applied, for instance, for wireless sensing in WLAN networks such as the amendment IEEE 802.11bf—Wireless Local Area Network (WLAN) Sensing. The fifth-generation (5G) New Radio (NR) standard, sixth-generation (6G) standards or other future standards may also apply wireless sensing as its part of future cellular communications networks. The present disclosure is also applicable to other communication technologies such as 3G or communication technologies under long-term evolution (LTE)/LTE Unlicensed (LTE-U). The present disclosure may be applied to any future type of a wireless network that may support wireless sensing.

Among the non-liner chirps, the hyperbolic chirps provide an inherent Doppler invariance. Thus, hyperbolic chirps facilitate a decoupled estimation of range and velocity.

A hyperbolic frequency modulated (sensing) signal is represented, for instance, as

$$x ( t ) = \{ \begin{matrix}cos ( - 2 π K ln ( 1 - \frac{t}{{t}_{0}} ) ) , - \frac{{T}_{c}}{2} \leq t \leq \frac{{T}_{c}}{2} & \\ 0 , & otherwise\end{matrix} ,$$

$$where$$

$${t}_{0} = \frac{{T}_{c} ( {f}_{H} + {f}_{L} )}{2 ( {f}_{H} - {f}_{L} )} , K = \frac{{T}_{c} {f}_{L} {f}_{H}}{( {f}_{H} - {f}_{L} )} .$$

Here, f_{L} and f_{H} corresponds to lower and upper bound of the sweep frequency range and T_{c} is the duration of the HFM chirp. The instantaneous frequency can be found by taking derivative of the phase inside the cosine function.

$$f ( t ) = \frac{1}{2 π} \frac{d}{dt} φ ( t ) = \frac{1}{2 π} \frac{d}{dt} [ - 2 π K ln ( 1 - \frac{t}{{t}_{0}} ) ] = \frac{K}{{t}_{0} - t}$$

The instantaneous frequency is the hyperbolic function of time, therefore the given signal is named as hyperbolic frequency modulated signal.

However, the present disclosure is not limited to this exemplar waveform. For example, the HFM chirp may comprise a time-dependent envelope a(t).

As already indicated above, NL-FM chirps are resilient to a wide range of Doppler shifts. In some embodiments, HFM chirps have inherent Doppler invariant property.

For example, the transmitter sends an HFM chirp represented as,

$${s}_{0} ( t ) = x ( t - \frac{{T}_{c}}{2} ) , 0 \leq t \leq {T}_{c} ,$$

with x(t) as defined above. The instantaneous frequency of the transmitted signal is given by

$${f}_{{s}_{0}} ( t ) = \frac{K}{{t}_{0} - ( t - \frac{{T}_{c}}{2} )} .$$

Due to the presence of a moving target, a Doppler shift ν is added to the received signal therefore, the phase of the received signal reads

$${φ}_{r} ( t ) = - 2 π K ln ( 1 - \frac{( 1 + v ) t - \frac{{T}_{c}}{2}}{{t}_{0}} ) .$$

Moreover, the instantaneous frequency of the received signal is defined as,

$${f}_{r} ( t ) = \frac{1}{2 π} \frac{d}{dt} {φ}_{r} ( t ) = \frac{( 1 + v ) K}{{t}_{0} - [ ( 1 + v ) t - \frac{{T}_{c}}{2} ]} .$$

By comparing transmitted and received instantaneous frequencies, the constant time delay Δt can be computed.

$${f}_{r} ( t - Δ t ) = {f}_{{s}_{0}} ( t ) , Δ t = \frac{v}{1 + v} ( {t}_{0} + \frac{{T}_{c}}{2} ) .$$

This indicates that even in the presence of Doppler, the matched filter corresponds to a translation in time. Therefore, it is justified that HFM chirp has inherent Doppler invariant property.

Moreover, if the source transmits an LFM signal under the identical conditions, it is observed that not only the initial frequency but also the frequency modulation rate is altered, implying that the received signal can no longer be matched to the matched filter, as well as the amplitude of the peak value at the matched filter's output will be significantly lowered.

For delay and Doppler estimation, two NL-FM chirps with up and down sweep rates respectively are transmitted. In an exemplary implementation, these two chirps are two HFM chirps with up and down sweep rates respectively. A chirp, whose frequency transitions from f_{L} to f_{H}, is called up-chirp. Alternatively, a chirp having a frequency variation from f_{H} to f_{L} is regarded as down chirp. Hence, the transmitted signal can be expressed as

$$s ( t ) = \{ \begin{matrix}x ( t - \frac{{T}_{c}}{2} ) , 0 \leq t \leq {T}_{c} \\ x ( \frac{3 {T}_{c}}{2} - t ) , {T}_{c} \leq t \leq 2 {T}_{c} \\ 0 , otherwise\end{matrix}$$

x(t) is the above-defined hyperbolic frequency modulated signal. The parameters of an up-chirp may be chosen as

$${t}_{0}^{u} = \frac{{T}_{c} ( {f}_{H} + {f}_{L} )}{2 ( {f}_{H} - {f}_{L} )} , {K}^{u} = \frac{{T}_{c} {f}_{L} {f}_{H}}{{f}_{H} - {f}_{L}} .$$

Similarly, the parameters of down-chirp are

$${t}_{0}^{d} = \frac{{T}_{c} ( {f}_{L} + {f}_{H} )}{2 ( {f}_{L} - {f}_{H} )} = - {t}_{0}^{u} , {K}^{d} = \frac{{T}_{c} {f}_{L} {f}_{H}}{{f}_{L} - {f}_{H}} = - {K}^{u} .$$

At the receiver, two correlators are used to determine delay and Doppler. The Doppler (scale) ν is defined as the ratio of the relative velocity between the source and the receiver to the propagation wave velocity. Note that the relative velocity is positive when the source and the receiver are moving closer to each other.

The output of a first correlator determines the time difference between the correlation peak position and the start position of received up-chirp HFM signal, which is given as

$$Δ {t}_{1} = \frac{v}{1 + v} ( {t}_{0}^{u} + \frac{{T}_{c}}{2} ) .$$

Therefore, the correlation peak position of first correlator with respect to the start position of the received signal is given as

$${t}_{1} = τ - Δ {t}_{1} = τ - \frac{v}{1 + v} ( {t}_{0}^{u} + \frac{{T}_{c}}{2} ) ,$$

wherein τ and t₁ refer to the starting position of the received signal and the correlation peak position of the first correlator, respectively.

A second correlator yields the time difference between the correlation peak position and starting position of the received HFM down-chirp. Such time difference is represented as

$$Δ {t}_{2} = \frac{v}{1 + v} ( {t}_{0}^{d} + \frac{{T}_{c}}{2} ) = \frac{v}{1 + v} ( - {t}_{0}^{u} + \frac{{T}_{c}}{2} ) .$$

Because of the presence of Doppler shift, the time gap between the starting position of the received up-chirp and down-chirp HFM signal is given as

$$\frac{{T}_{c}}{( 1 + v )} .$$

Therefore, the second correlator produces the correlation peak position with respect to the starting position of the received signal at

$${t}_{2} = τ + \frac{{T}_{c}}{( 1 + v )} - Δ {t}_{2} = τ + \frac{{T}_{c}}{( 1 + v )} - \frac{v}{1 + v} ( - {t}_{0}^{u} + \frac{{T}_{c}}{2} ) ,$$

wherein τ is the starting position of the received signal and t₂ is the correlation peak position of second correlator. By solving t₁ and t₂, the Doppler is found as

$$v = \frac{{t}_{2} - {t}_{1} - {T}_{c}}{2 {t}_{0}^{u} - ( {t}_{2} - {t}_{1} )} .$$

The range R of the target may be determined using the starting position of the received signal τ,

$$R = \frac{1}{2}$$

### Adaptive Frame Format

Wireless sensing has been prevalently studied in the Wi-Fi bands such as 2.5 gigahertz (GHz), 5 GHz, and above 60 GHz. As such, there may be interference to and from other Wi-Fi devices, and opportunistic cellular devices. Wireless communication may require varying levels of security, throughput, and latency. However, possible interference from sensing devices may reduce wireless communication performance. In order to mitigate this, JSC signals or waveforms can be used. As a result, there may be a number of combinations of frame designs, waveforms, and transmission mechanisms, which can be used to satisfy both communication and sensing.

It is desired that wireless sensing, communication, and JSC devices operate/coexist peacefully in the same (or at least partially overlapping) frequency bands with a maximum efficiency, in terms of spectrum usage, power, or the like, and sensing and communication performance, in terms of throughput, reliability, sensing accuracy, and/or the like.

A Frequency-Modulated Continuous Wave (FMCW) waveform or a chirp signal is widely adopted for sensing due to its ease of generation and processing. However, as explained in section Chirps as sensing signals, the processing of a linear chirp involves the extraction of range and Doppler of a moving target in a coupled manner using a two-dimensional fast Fourier transform (2D-FFT). Therefore, there is an issue of range-Doppler coupling with linear frequency modulated chirp signals, which causes the displacement in the actual range of a target due to relative velocity of an object. This offset in the range may lead to inaccurate target tracking. Moreover, the effect of range-Doppler coupling is more pronounced in the high mobility scenarios. On the other hand, using a sensing signal adapted for high mobility scenarios, for example a non-linear chirp, may be a surplus resource in a case where the targets' dynamics are sufficient to be captured by a LFM chirp, e.g., in a low mobility scenario. Although non-linear chirps offer significant performance gains over linear chirps, their generation and processing is more complex.

In addition, a fixed communication waveform may lead to certain limitations. For example, orthogonal frequency division multiplexing (OFDM) is the dominant communication waveform in contemporary 4G and 5G networks. Due to the presence of orthogonal subcarriers, OFDM delivers high multiplexing capabilities in time and frequency through OFDM resource elements. The cyclic prefix converts the linear convolution of the transmit signal with the propagation channel impulse response to a circular convolution hence enabling simple frequency domain equalization at the receiver. However, OFDM suffers from high peak-to-average-power-ratio (PAPR) which decreases the energy efficiency of the transmitter. Moreover, in high mobility scenarios, the orthogonal subcarriers of OFDM might lose their inherent orthogonality, which may lead to inter-carrier interference (ICI) and may result in degraded communication performance.

A suitable sensing and/or communication performance may not be effectively feasible with a single fixed frame design and transmission mechanism. Each design and mechanism has its own advantages and drawbacks. Therefore, an adaptive and flexible frame design and transmission mechanism selection framework may be advantageous.

For transmitting a sensing signal, an estimation of a mobility of a wireless (communication) device is obtained. Said wireless device is a target device for the sensing. For example, the sensing signal may be reflected from said wireless device. For example, the sensing signal may be received by said wireless device. In response to receiving the sensing signal, the wireless device may transmit a feedback signal. Such a feedback signal may comprise, for example, information about the received sensing signal (e.g., characteristics of the received signal) and/or information obtained from the received sensing signal (e.g., an estimation of range and/or velocity), and/or the like.

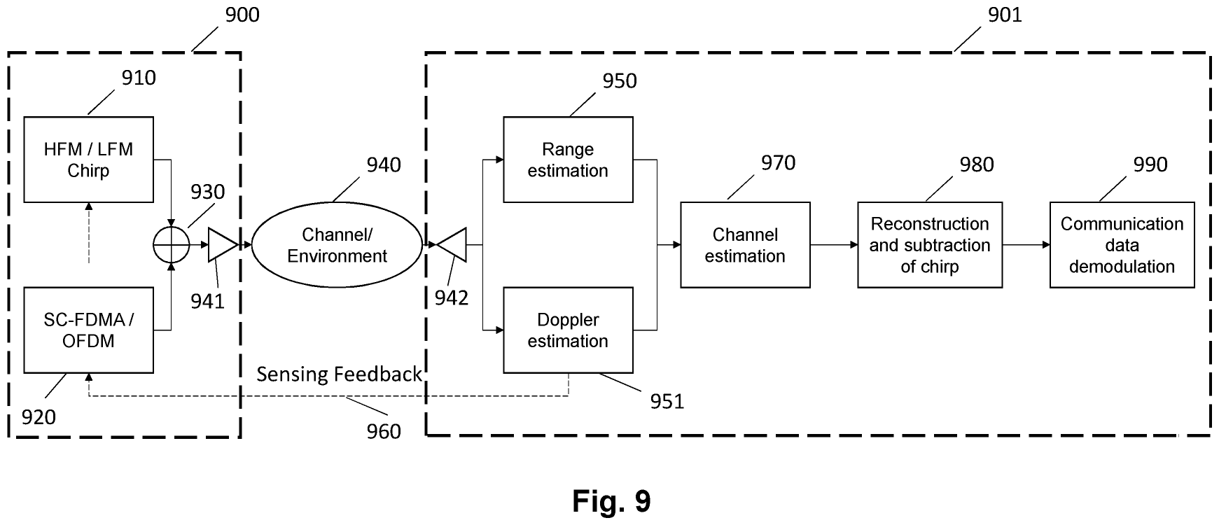

FIG. 9 exemplarily illustrates a wireless device 900, transmitting a sensing signal 910 using a transmitter 941. The transmitting wireless device 900 is coupled wirelessly to a channel (environment) 940. A receiving wireless device 901 is also coupled wirelessly to said channel/environment 940 and receives a transmitted signal via a receiver 942.

The channel or radio frequency environment may comprise multiple mobile or stationary targets/objects, which may induce a delay and/or a Doppler shift to the input transmitted signal. It is assumed that these parameters are constant during a coherent processing interval T.

Therefore, the received signal (e.g., signal received at the receiving wireless device 901) may be represented as

$$y ( t ) = {\sum }_{k = 1}^{K} {h}_{k} s ( t - {τ}_{k} ) {e}^{2 j π ( {f}_{c} + {f}_{v} )} + n ( t ) ,$$

wherein hₖ represents the effect of the channel for the k^{th} target, where k represents the number of objects present in the environment that need to be sensed/detected. These targets are the objects whose range/velocity may be determined using sensing signals including chirps. s(t) is the transmitted signal and τₖ is the delay between transmitted signal and the target. Moreover, f_{c} is the frequency of the transmitted signal and fᵥ is the Doppler shift, which is caused by the movement of the target. n(t) represents additive white Gaussian noise with variance σ² In the exemplary illustration of FIG. 9, a feedback signal is transmitted from wireless device 901 to wireless device 900. The information such as estimated range and estimated velocity may be sent to the transmitter as a feedback. The transmitter may allocate appropriate resources (sensing and communication waveform) for a mobility scenario estimated based on the feedback signal.

A wireless device 901, whose mobility is estimated, may be, for example, a terminal or any other wireless device including a receiver Rx, as explained above with respect to FIG. 1. The sensing signal to be transmitted may be a pure sensing signal or may be part of a joint sensing and communication signal, or the like. The sensing signal is transmitted by another wireless device 900. Such transmitting wireless device 900 may be, for example, a base station, a terminal, or any other wireless device comprising a transmitter Tx, as explained above with respect to FIG. 1. Any of the receiving and/or transmitting wireless devices may be a wireless communication device.

The estimation of the mobility comprises, for example, a determination of range and/or velocity. Such estimation may be performed by the receiving or by the transmitting wireless device. The mobility of a wireless communication device may be classified, for example, into in a high mobility region and a low mobility region depending on range and/or velocity.

The estimation of the mobility of the receiving wireless device may comprise a determination of range and/or velocity using a sensing signal that is transmitted by the transmitting wireless device. In an exemplary implementation, a sensing signal having a first waveform is transmitted to the wireless device.

As explained above, a sensing signal of a first waveform may be a NL-FM chirp or a HFM chirp, which are suitable for an accurate range and velocity estimation in high mobility scenarios (and also in low mobility scenarios). Thus, in case of an unknown range and/or velocity of a wireless target device using a sensing signal suitable for multiple scenarios is advantageous.

In response to said sensing signal, a feedback signal is received from said wireless device. Such a feedback signal may comprise a mobility estimation and/or information to perform a mobility estimation. The feedback signal may comprise an indication of a mobility class.

For example, the receiving wireless device 901 may receive the sensing signal and may perform a mobility estimation. Such mobility estimation may comprise a range and/or velocity estimation. A result of such estimation may be comprised in the feedback signal. In other words, the feedback signal may comprise range information and/or velocity information. Such information may be obtained by a range-Doppler estimation performed by said receiving wireless device. The exemplary implementation of FIG. 9 shows a range estimation 950 and a Doppler (scale) estimation 951 performed by the receiving wireless device 901. A range and Doppler estimation is explained in detail for LFM chirps and HFM chirps in section Chirps as sensing signals. If the receiving wireless device 901 transmits information about range and/or velocity, a determination of a mobility class may be performed at the transmitting device 900. Alternatively, the receiving wireless device 901 may determine a mobility class according to the estimated range and/or velocity. The feedback signal may comprise an indication for such a mobility class. Performing the estimation in the receiving wireless device may result in less data to be transmitted in the feedback signal.

For example, information about the received sensing signal may be comprised into the feedback signal. The wireless device that transmitted the sensing signal may perform a mobility estimation based on the received information. In other words, the obtaining of the estimation of mobility comprises performing the estimation according to the feedback signal. In such an exemplary implementation the range estimation 950 and Doppler (scale) estimation 951 of FIG. 9 may be comprised in the transmitting device 900 and may receive the sensing feedback 960 as input. Thus, the transmitting wireless device 900 may perform the estimation of the range and/or the velocity. Thus, the processing at the receiving wireless device 901 is reduced.

A transmitting device 900 and a receiving device 901 may be configured to perform any of the above-described steps for feedback individually or in combination. The transmitting device 900 and the receiving device 901 may be further configured to select a suitable method according to a standard, a transmitter configuration, a receiver configuration, transmitter capabilities, receiver capabilities, or the like.

The feedback signals may be sent by the receiver to the transmitter as a control signal. The feedback may be sent together with further control signals or separately. For example, the feedback signal may be sent via uplink pilots. For example, one or more parameters (e.g., phase) of a pilot signal may by modulated while other one or more parameters (e.g., power) of the same pilot signal may be fixed (predefined or pre-negotiated, i.e., and known to the transmitter and receiver). However, the present disclosure is not limited to transmitting feedback signals via control signals or pilots. In general, any transmission from the receiving wireless device 901 to the transmitting wireless device 900 may be used.

Parameters of the first waveform and/or the second waveform may be altered based on the sensing feedback to match the range resolution and Doppler requirements of the estimated mobility environment.

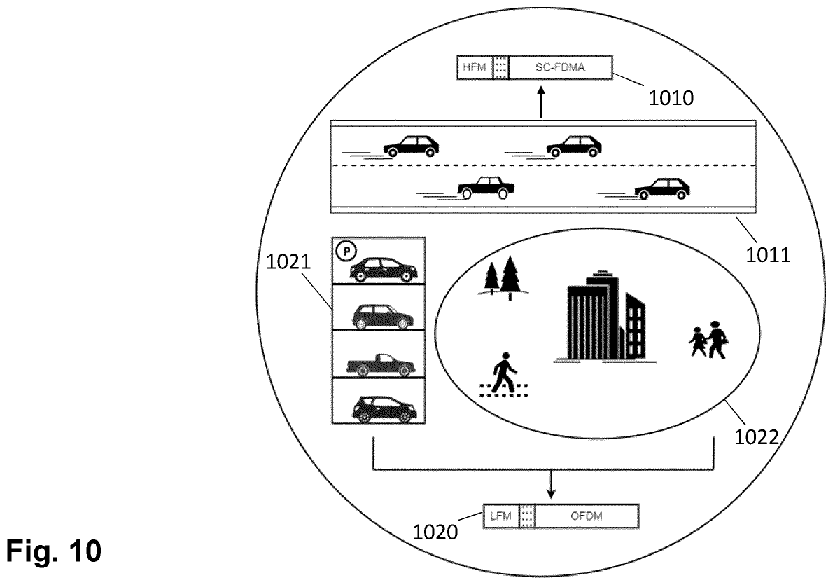

An example for such splitting into mobility regions (mobility classes) is given in FIG. 10. In case of a high mobility scenario, e.g., a car 1011 moving at a velocity higher than a threshold value, a first frame format 1010 is selected. In case of a low mobility scenario, e.g., parking car detection 1021, pedestrian detection or indoor scenarios 1022, a second frame format 1020 is selected.

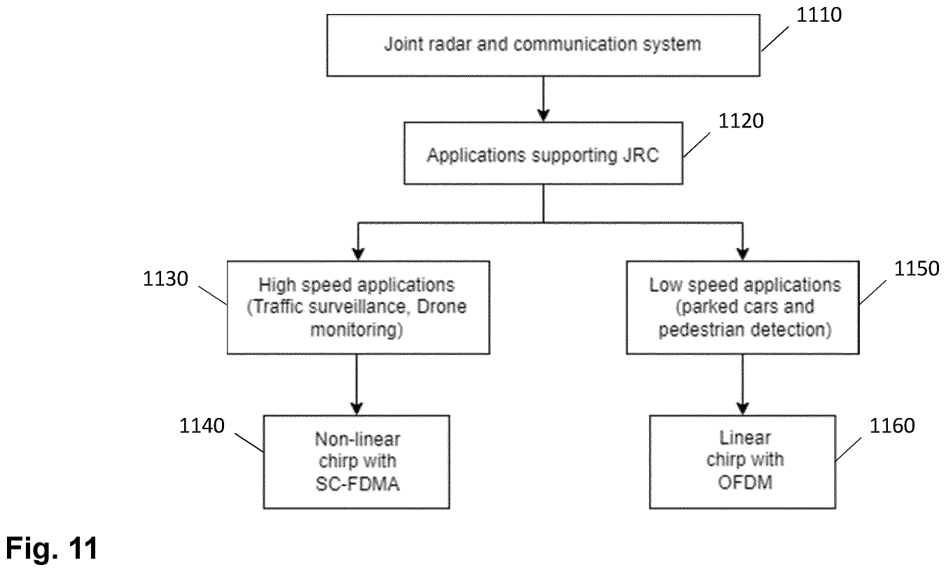

FIG. 11 illustrates such an exemplary division into mobility classes. In a system 1110 that supports joint sensing (radar) and communication applications 1120, high speed scenarios 1130 and low speed scenarios 1140 are distinguished. A first frame format 1140 is chosen for high speed scenarios and a second frame format 1160 is chosen for low speed scenarios.

The present disclosure is not limited to these two exemplary mobility classes; there may be additional mobility classes. A set of two or more mobility classes may be obtained, for example, from a standard, a configuration of the transmitter, a configuration of the receiver, or the like, or any combination thereof.

If a condition based on the estimation is fulfilled, a first frame comprising a sensing signal having a first waveform is transmitted to the wireless communication device. In other words, when the estimation fulfills the condition, a frame having a first frame format is transmitted.

If the condition based on the estimation is not fulfilled, a second frame comprising a sensing signal having a second waveform is transmitted to said communication device. The second waveform is different from the first waveform. In other words, when the estimation does not fulfill the condition, a frame having a second frame format is transmitted. The second frame format is different from the first frame format.

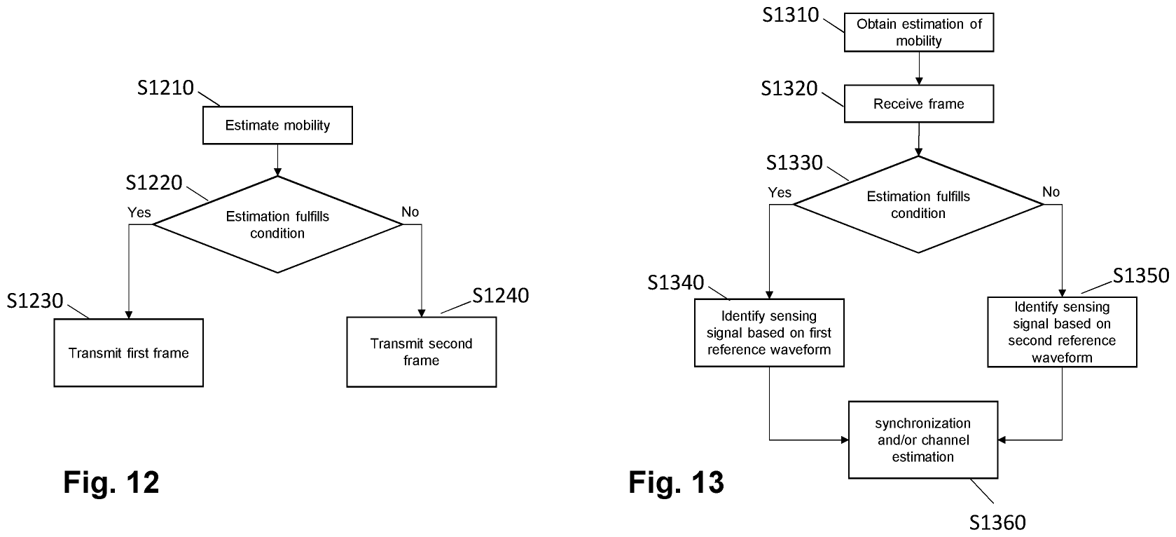

FIG. 12 provides an exemplary flowchart for such a method. The mobility of a wireless device is estimated S1210. It is determined S1220 whether or not the estimation fulfills a condition. If the condition is fulfilled (“Yes” in S1220), a first frame is transmitted S1230. If the condition is not fulfilled (“No” in S1220), a second frame is transmitted S1240.

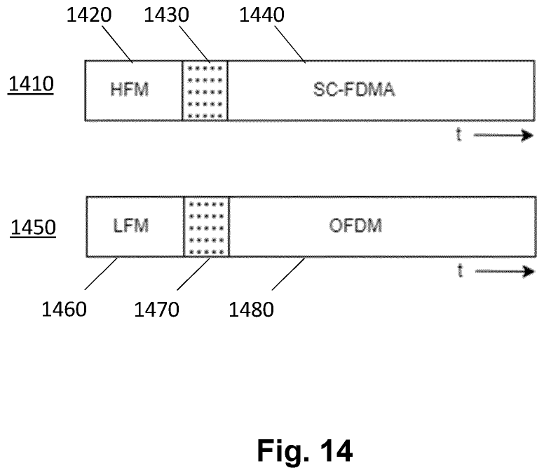

In FIG. 14, a first frame 1410 and a second frame 1450 are illustrated exemplarily. The first frame 1410 comprises a sensing signal having a first waveform 1420, which is for example a HFM chirp. The second frame 1450 comprises a sensing signal having a second waveform 1460, which is for example a LFM chirp.

The above-mentioned condition is based on the estimation of the mobility of the wireless device. For example, the condition may be based on the velocity of the wireless communication device. For example, the condition may comprise a predetermined threshold of the velocity. The estimated mobility (velocity) may be compared to such predetermined threshold. For example, in the case, when the estimated velocity is higher than such threshold the condition is fulfilled. In this example, if the estimated velocity is lower than such threshold, the condition is not fulfilled.

The selection of a mobility scenario may be based on the velocity of the target object (wireless communication device). Some exemplary mobility and non-mobility scenarios, which are illustrated exemplarily in FIG. 10, are mentioned in the following table together with a desired range resolution.

| | Range | | Approximate | |
|---|---|---|---|---|
| Application | Resolution | | Speed | |
| Traffic surveillance/monitoring | 1 | m | 40 m/s | (144 km/h) |
| Drone monitoring | 1 | m | 30 m/s | (108 km/h) |
| Parked car detection | 50 | cm | NA | |
| Pedestrian detection | 10 | cm | 3 m/s | (10.8 km/h) |
| Motion detection/sensing | <10 | cm | 1 m/s | (3.6 km/h) |

For example, moving objects having a velocity of 100 km/h and above may be considered as high mobility scenarios. For example, the velocity of moving objects below or at approximately 10 km/h may be referred as low mobility scenario.

Such predetermined (velocity) thresholds, which may correspond to the above-mentioned two or more mobility classes, may be obtained, for example, from a standard, a configuration of the transmitter, a configuration of the receiver, or the like, or a combination thereof.

In an exemplary implementation, the first frame 1410 may be selected in case of a high mobility scenario. The first waveform of the sensing signal may comprise one or more non-linear chirps. As mentioned above, NL-FM chirps provide advantageous properties in case of a high mobility scenario, for example, a more accurate prediction of range and velocity of moving targets. For example, at least one of the one or more non-linear chirps in the first waveform is a hyperbolic chirp. A detailed explanation of NL-FM chirps and HFM chirps can be found in section Chirps as sensing signals. For example, in high mobility applications such as traffic surveillance and drone monitoring, in a WLAN network (e.g., IEEE 802.11bf) the following parameters may be chosen for a HFM chirp: Chirp duration T_{C}=2 ms, Bandwidth=150 MHz operating around 60 GHz.

For example, a first non-linear chirp out of the one or more non-linear chirps has an increasing frequency and a second non-linear chirp out of the one or more non-linear chirps has a decreasing frequency. Such an arrangement of chirps corresponds to the above-mentioned combination of up-chirp and down-chirp, which facilitates a decoupled determination of a Doppler scale of a moving target.

In said exemplary implementation, the second frame 1450 may be selected in case of a low mobility scenario. The second waveform of the sensing may comprise a linear chirp. A detailed explanation of LFM chirps can be found in section Chirps as sensing signals. For example, in low mobility applications such as indoor applications, in a WLAN network (e.g., IEEE 802.11bf) the following parameters may be chosen for a LFM chirp: Chirp duration T_{C}=0.5 ms, Bandwidth=140 MHz operating around 5 GHz.

In addition to a sensing signal, the first frame 1410 and/or the second frame 1450 may comprise a communication signal. In other words, any of the first frame 1410 and the second frame 1450 may be a joint sensing and communication (JSC) frame. Such communication signal may follow the sensing signal within the frame. This is illustrated exemplarily in FIG. 14. In the first frame 1410, the sensing signal 1420 is followed by a communication signal 1440. The communication signal 1440 may follow the sensing signal 1420 directly. For example, a guard period 1430 may be comprised in the frame, directly following the sensing signal 1420. Such guard period may (directly) precede the communication signal 1440. Analogously, the sensing signal 1460 in the second frame 1450 is followed by a communication signal 1480. For example, the communication signal 1480 may follow the sensing signal 1460 directly. For example, a guard period 1470 may be comprised in the frame between the sensing signal 1460 and the following communication signal 1480.

For example, the first frame 1410 may comprise a communication signal having a single-carrier structure 1440. Such signal may have, for example, a single-carrier frequency division multiple access (SC-FDMA) structure or the like. A SC-FDMA signal may be obtained by a discrete Fourier transform (DFT) spreading on top of OFDM. A SC-FDMA communication signal may to enhance energy efficiency and error-free transmission in high mobility scenarios.

For example, the second frame 1450 may comprise a communication signal having a multi-carrier structure 1480. Such multi-carrier signal may be, for example, an OFDM signal, a Generalized FDM (GFDM) or the like. An OFDM communication signal facilitates high data rates in low mobility scenarios.

FIG. 9 exemplarily illustrates the generation of such a first frame and/or second frame. The generation is based on the estimation, which is obtained by the wireless device 900 by a feedback signal 960 in this example. A sensing signal waveform 910 is selected according to the feedback 960. In addition, a communication signal waveform 920 is selected according to the feedback 960. The sensing signal and the communication signal are multiplexed (combined) 930 into a frame.

A receiving of a sensing signal by a wireless (communication) device is illustrated in the flowchart in FIG. 13. For receiving a sensing signal, an estimation of a mobility of said wireless communication device 901 is obtained S1310. As discussed in detail above, such estimation may be performed by a wireless communication device 900 transmitting the sensing signal or by the wireless communication device 901 receiving the sensing signal. Such estimation may yield a range and/or a velocity of the receiving wireless communication device. A result of such an estimation may correspond to one of the two or more above-mentioned mobility classes.

The wireless communication device receives S1320 a frame including a sensing signal. If the estimation fulfills a condition (“Yes” in S1330), the sensing signal is identified S1340 based on a first reference waveform. If the estimation does not fulfil a condition (“No” in S1330), the sensing signal is identified S1350 based on a second reference waveform.

Analogous to the transmitting, the condition may be based on the estimation of the mobility of the wireless device. For example, the condition may be based on the velocity of the wireless communication device. For example, the condition may comprise a predetermined threshold of the velocity. The estimated mobility (velocity) may be compared to such predetermined threshold. For example, in the case, when the estimated velocity is higher than such threshold the condition is fulfilled. In this example, if the estimated velocity is lower than such threshold, the condition is not fulfilled.

As mentioned above, the received signal y(t) comprise an effect hₖ of the channel for the k^{th} target. A synchronization and/or channel estimation 970 is performed using the identified sensing signal. Such an estimation 970 of the channel coefficients hₖ for the k^{th} target facilitates an equalization process at the receiver. Here, the waveform dedicated for sensing is leveraged to perform channel estimation for communication.

The identification of a received signal is based on a reference signal. In other words, characteristics (parameters), such as starting time, duration, frequency at a certain time, frequency sweep, peak position(s), and/or the like, of a received signal are compared with a reference signal. Such reference signal is known by the receiver. A reference signal may be determined by a standard, a configuration of transmitter and/or receiver, and/or the like. Identification of sensing signal is explained in detail in section Identification of sensing signals. The first and the second waveform of the reference signal correspond to the waveforms of the transmitted sensing signals as explained in detail above. For example, a first reference signal waveform may comprise one or more non-linear chirps, i.e. NL-FM chirps. At least one of the one or more non-linear chirps may be, for instance, a hyperbolic chirp. For example, a first non-linear chirp out of the one or more non-linear chirps has an increasing frequency and a second non-linear chirp out of the one or more non-linear chirps has a decreasing frequency. Corresponding to the transmitting of the sensing signal, the second reference waveform may be a linear chirp.

The estimation of the mobility of the receiving wireless device may comprise a determination of range and/or velocity using a sensing signal that is transmitted by the transmitting wireless device 900. In an exemplary implementation, a sensing signal having a first waveform is transmitted to the wireless device 901. As mentioned above, such first waveform may be a NL-FM chirp, which is suitable for a range and/or Doppler estimation in high and low mobility scenario. Such a non-linear chirp is suitable to estimate a yet unknown mobility. Thus, the obtaining of the estimation may comprise receiving a sensing signal and identifying the received sensing signal based on the first reference waveform. Based on the identification an estimation of a range and/or a velocity of the wireless communication device 901 may be obtained. In other words, the characteristics (parameters) of the received sensing signal are compared with the reference waveform to determine a range and/or a velocity. Such range estimation 950 and Doppler estimation 951 may be performed as explained in section Chirps as sensing signals.

Information on the estimated range and/or velocity may be transmitted. In other words, a feedback signal comprising information on the estimated range and/or velocity is transmitted to the wireless devices, which transmits the sensing signal.

The first chirp, i.e., a sensing signal of a first waveform (e.g., a HFM chirp) that is transmitted for mobility scenario prediction may be also exploited for the channel estimation as explained above. For example, a least square channel estimation method may be used.

At the receiver, a composite signal (i.e., the frame) is received, which consists of both sensing (radar) signal and communication data. For the extraction of data, the sensing signal may be subtracted from the received signal. Such signal processing is exemplarily shown in FIG. 9.

The received frame may be reconstructed based on the identification of the sensing signal comprised in the received frame. In other words, the parameters of the transmitted sensing signal are known at the receiver by the reference waveform, therefore the received frame (comprising the sensing signal) is reconstructed at the receiver. The sensing signal is subtracted from the received frame. For subtracting the sensing signal, a position of the sensing signal within the received signal may be determined through a correlation process. A communication signal comprised in the frame is obtained from the remaining part of the frame.

The obtained communication signal has a single-carrier structure, if the estimation fulfills a condition. In an exemplary implementation, this corresponds to a high mobility scenario, in which a first frame 1410 is received, comprising, for example, a SC-FDMA communication signal 1440. If the estimation does not fulfill a condition, the obtained communication signal has a multi-carrier structure. In said exemplary implementation, this corresponds to a low mobility scenario, wherein a second frame 1450 is received, comprising, for example, an OFDM communication signal 1480.

The obtained communication signal may comprise modulated communication data, which may be demodulated 990 to extract the communication data.

In an exemplary implementation of the above-described methods, a first sensing signal comprising a HFM chirp is transmitted by a transmitting device in order to obtain an estimation of the mobility of the target wireless device. The target device performs an estimation of the range and the velocity based on a comparison of the characteristics of the received sensing signal and a reference waveform. A feedback signal comprising information about range and velocity is transmitted from the target device to the transmitting device. Using said information, the transmitting device determines whether a condition regarding the mobility (velocity) of the target device is fulfilled. In said exemplary implementation, the mobility of the target device is classified either as high mobility scenario or as low mobility scenario according to a predetermined threshold of the velocity.

In a high mobility scenario, a first frame format is selected. Such a first frame format 1410 in said exemplary implementation comprises at least one HFM chirp 1420 as sensing signal and a single-carrier communication signal 1440, e.g., a SC-FDMA signal. Such frame structure is advantageous for a high mobility scenario, as the sensing signal is suitable for a more precise determination of range and/or velocity due to the non-linear chirp waveform. In addition, a single-carrier communication signal waveform avoids inter-symbol interference in high mobility scenarios.

In a low mobility scenario, a second frame format is selected. Such a second frame format 1450 in said exemplary implementation comprises at least one LFM chirp 14260 as sensing signal and a multi-carrier communication signal 1440, e.g., an OFDM signal. To detect stationary objects such as parked cars (car parking spots), the range resolution should be less than the general vehicular dimensions. The Doppler resolution is not a concern in such a scenario; thus, the range-Doppler issue of the LFM chirps may be disregarded. Therefore, accurate sensing along with high data rates is achieved in such a low mobility scenario, where targets are stationary or possess very low speeds.

However, the present disclosure is not limited to this exemplary implementation. The above-described exemplary implementations may be performed individually as well as in combination.

Moreover, note that the present disclosure is not limited to the above-mentioned exemplary networks. For instance, the amendment IEEE 802.11bf—Wireless Local Area Network (WLAN) Sensing—may comprise support for wireless sensing in WLAN networks. The fifth-generation (5G) New Radio (NR) standard, sixth-generation (6G) standards or other future standards may also apply wireless sensing as its part of future cellular communications networks. The present disclosure is also applicable to other communication technologies such as 3G or communication technologies under long-term evolution (LTE)/LTE Unlicensed (LTE-U). The present disclosure may be applied to any future type of a wireless network that may support wireless sensing.

### Implementations in Software and Hardware

It is noted that although embodiments and examples of the present disclosure were provided in terms of a method above, the corresponding devices providing the functionality described by the methods are also provided. Moreover, it is noted that any of the steps described above may be comprised as code instructions in a program, which may be executed by one or more processors.

For example, a device is provided for transmitting and or receiving sensing signals. The device may comprise a processing circuitry, which is configured to perform steps according to any of the above-mentioned methods. The device may further comprise a transceiver for performing wireless reception, transmission or sensing. Alternatively to the transceiver, the processing circuitry may control an external transceiver to perform wireless reception, transmission or sensing. The processing circuitry may receive signals from a transceiver and/or may transmit signals to a transceiver. In other words, the processing circuitry may instruct the transceiver to receive and/or transmit signals.

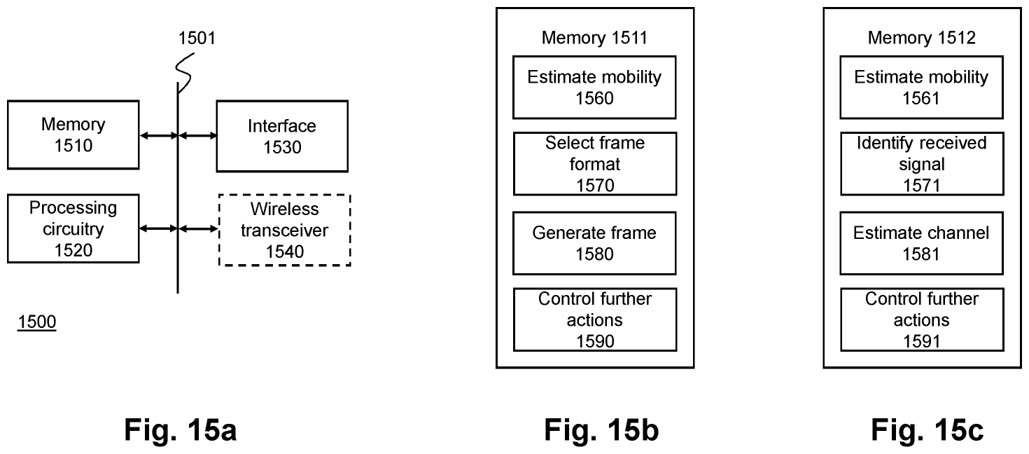

FIG. 15a shows an exemplary device 1500, which may implement some embodiments of the present disclosure. For example, the device may be the device for scheduling sensing signals. Such a device may comprise memory 1510, processing circuitry 1520, a wireless transceiver 1540, and possibly a user interface 1530. The device may be, for instance a (part of) a base station or a terminal/STA, or another device as mentioned above.

The memory 1510 may store the program, which may be executed by the processing circuitry 1520 to perform steps of any of the above-mentioned methods. The processing circuitry may comprise one or more processors and/or other dedicated or programmable hardware. The wireless transceiver 1540 may be configured to receive and/or transmit wireless signals. The transceiver 1540 may also comprise baseband processing which may detect, decode and interpret the data according to some standard or predefined convention. However, this is not necessary and devices with only sensing applications may implement only the lower one or two protocol layers. For example, the transceiver may be used to perform measurement, communicate with other devices such as base stations and/or terminals. The device 1500 may further comprise a user interface 1530 for displaying messages or status of the device, or the like and/or for receiving a user's input. A bus 1501 interconnects the memory, the processing circuitry, the wireless transceiver, and the user interface.

FIG. 15b shows an example of the memory 1511 in a wireless device 1500 for transmitting a sensing signal, comprising a module 1560 for estimating mobility, a module 1570 for selecting a frame format, a module 1580 for generating a frame, and a module 1590 for controlling the transceiver 1540 to adapt the wireless reception, transmission or sensing. These modules 1560-1590 may be fetched from the memory and executed by the processing circuitry 1520.

FIG. 15c shows an example of the memory 1512 in a wireless device 1500 for receiving a sensing signal, comprising a module 1561 for estimating mobility, a module 1571 for identifying a received signal, a module 1581 for estimating a channel, and a module 1591 for controlling the transceiver 1540 to adapt the wireless reception, transmission or sensing. These modules 1560-1590 may be fetched from the memory and executed by the processing circuitry 1520.

The above examples are not to limit the present disclosure. There are many modifications and configurations, which may be used in addition or alternatively, as will be briefly described below.

FIGS. 15b and c provide an exemplary implementation. A memory 1510 may comprise a subset of the described modules or additional modules to provide instructions to perform any of the methods described in the sections above.

For example, the exemplary device 1500 may be configured to transmit a sensing signal including a non-linear chirp. The processing circuitry 1520 may be configured to transmit a frame including a sensing signal including at least one non-linear chirp. As explained in section Chirps as sensing signals, non-linear chirps, such as hyperbolic chirps, provide advantages compared to other sensing signals, such as linear chirps.

For example, the exemplary device 1500 may be configured to receive a sensing signal including a non-linear chirp. The processing circuitry 1520 may be configured to receive a frame including a sensing signal, identify the sensing signal based on a reference waveform of a non-linear chirp, and perform a synchronization and/or channel estimation using the identified sensing signal.

This present disclosure can be used in any kind of device that is used for wireless sensing. For instance, health monitoring, activity classification, gesture recognition, people counting, through the wall sensing, emotion recognition, attention monitoring, keystrokes recognition, drawing in the air, imaging, step counting, speed estimation, sleep detection, traffic monitoring, smoking detection, metal detection, sign language recognition, humidity estimation, wheat moisture detection, fruit ripeness detection, and/or sneeze sensing, etc. Besides these applications, the embodiments of the present disclosure can be used in JSC technologies. This disclosure can also be used for sensing applications to support communication applications, like obstacle tracking for beam management. Therefore, devices that can utilize the disclosed subject matter could be smart homes/offices/cities/factories/etc. devices, like electrical kitchen appliances, television sets, smart bus stops, smart office equipment (printers, etc.), lighting systems, WLAN devices and/or WiFi devices, etc. Other devices could be stand-alone wireless sensors, such as heart-rate monitors, motion detectors, and/or smart watches, etc. Besides these applications, the disclosed subject matter can be used for military services such as enemy sensors, the existence of enemy devices and/or what they are sensing can be learned and some precaution can be taken. This disclosure can especially be used in network controllers and/or managing devices, such as APs, BSs, edge nodes, enhanced nodes, etc., for technologies such as CR, reconfigurable radio systems, etc.

The methodologies described herein may be implemented by various means depending upon the application. For example, these methodologies may be implemented in hardware, operation system, firmware, software, or any combination of two or all of them. For a hardware implementation, any processing circuitry 1520 may be used, which may comprise one or more processors. For example, the hardware may comprise one or more of application specific integrated circuits (ASICs), digital signal processors (DSPs), digital signal processing devices (DSPDs), programmable logic devices (PLDs), field programmable gate arrays (FPGAs), processors, controllers, any electronic devices, or other electronic circuitry units or elements designed to perform the functions described above.

If implemented as program code, the functions performed by the transmitting apparatus (device) may be stored as one or more instructions or code on a non-transitory computer readable storage medium such as the memory 1510 or any other type of storage. The computer-readable media comprises physical computer storage media, which may be any available medium that can be accessed by the computer, or, in general by the processing circuitry 1520. Such computer-readable media may comprise RAM, ROM, EEPROM, optical disk storage, magnetic disk storage, semiconductor storage, or other storage devices. Some particular and non-limiting examples comprise compact disc (CD), CD-ROM, laser disc, optical disc, digital versatile disc (DVD), Blu-ray (BD) disc or the like. Combinations of different storage media are also possible—in other words, distributed and heterogeneous storage may be employed.

The embodiments and exemplary implementations mentioned above show some non-limiting examples. It is understood that various modifications may be made without departing from the disclosed subject matter. For example, modifications may be made to adapt the examples to new systems and scenarios without departing from the central concept described herein.

### SELECTED EMBODIMENTS AND EXAMPLES

Summarizing, some embodiments in the present disclosure relate to transmitting and/or receiving sensing signals. Based on an estimation of the mobility of a wireless device, a frame format is selected and transmitted. In a first mobility scenario (e.g., a high mobility scenario), a first frame is transmitted that comprises a sensing signal having a first waveform. In a second mobility scenario (e.g., a low mobility scenario), a second frame is transmitted that comprises a sensing signal having a second waveform.

According to an embodiment, a method is provided for transmitting a sensing signal, the method comprising: obtaining an estimation of a mobility of a wireless communication device; and if a condition based on the estimation is fulfilled, transmitting a first frame comprising a sensing signal having a first waveform to said wireless communication device; or if the condition based on the estimation is not fulfilled, transmitting a second frame comprising a sensing signal having a second waveform different from the first waveform to said wireless communication device.

For example, the condition is based on a velocity of the wireless communication device.

In an exemplary implementation, the first waveform of the sensing signal comprises one or more non-linear chirps.

For example, at least one of the one or more non-linear chirps is a hyperbolic chirp.

In an exemplary implementation, a first non-linear chirp out of the one or more non-linear chirps has an increasing frequency and a second non-linear chirp out of the one or more non-linear chirps has a decreasing frequency.

For example, the second waveform of the sensing signal comprises a linear chirp.

In an exemplary implementation, the first frame comprises a communication signal having a single-carrier structure.

For example, the second frame comprises a communication signal having a multi-carrier structure.

In an exemplary implementation, the obtaining of the estimation further comprises: transmitting a sensing signal having the first waveform to said wireless communication device, and receiving a feedback signal from said wireless communication device.

For example, the obtaining of the estimation further comprises performing the estimation according to the feedback signal.

In an exemplary implementation, the feedback signal comprises range information and/or velocity information.

According to an embodiment, a method is provided for receiving a sensing signal by a wireless communication device, the method comprising: obtaining an estimation of a mobility of the wireless communication device; receiving a frame comprising a sensing signal; identifying the sensing signal based on a first reference waveform, if the estimation fulfills a condition; or identifying the sensing signal based on a second reference waveform, if the estimation does not fulfill the condition; and performing a synchronization and/or channel estimation using the identified sensing signal.

For example, the condition is based on a velocity of the wireless communication device.

In an exemplary implementation, the first reference waveform of the sensing signal comprises one or more non-linear chirps.

For example, at least one of the one or more non-linear chirps is a hyperbolic chirp.

In an exemplary implementation, a first non-linear chirp out of the one or more non-linear chirps has an increasing frequency and a second non-linear chirp out of the one or more non-linear chirps has a decreasing frequency.

For example, the second reference waveform of the sensing signal is a linear chirp.

In an exemplary implementation, the obtaining of the estimation further comprises: receiving a sensing signal, identifying the received sensing signal based on the first reference waveform, and obtaining an estimation of a range and/or a velocity of the wireless communication device based on the identification.

For example, the obtaining of the estimation further comprises: transmitting information on the estimation of the range and/or the velocity.

In an exemplary implementation, the method is further comprising: reconstructing the received frame based on the identification of the sensing signal comprised in the received frame, subtracting the sensing signal from the frame, and obtaining a communication signal comprised in the frame.

For example, the obtained communication signal has a single-carrier structure, if the estimation fulfills the condition, and the obtained communication signal has a multi-carrier structure, if the estimation does not fulfill the condition.

In an exemplary implementation, a computer program stored in a non-transitory, computer-readable medium, the program comprising code instructions which, when executed on one or more processors, cause the one or more processors to perform steps of any of the above-described methods.

According to an embodiment, a wireless communication device is provided for transmitting a sensing signal, comprising: processing circuitry configured to obtain an estimation of a mobility of a second wireless communication device; and if a condition based on the estimation is fulfilled, transmit a first frame including a sensing signal having a first waveform to said second wireless communication device; or if the condition based on the estimation is not fulfilled, transmit a second frame including a sensing signal having a second waveform different from the first waveform to said second wireless communication device.

For example, the condition is based on a velocity of the second wireless communication device.

In an exemplary implementation, the first waveform of the sensing signal comprises one or more non-linear chirps.

For example, at least one of the one or more non-linear chirps is a hyperbolic chirp.

In an exemplary implementation, a first non-linear chirp out of the one or more non-linear chirps has an increasing frequency and a second non-linear chirp out of the one or more non-linear chirps has a decreasing frequency.

For example, the second waveform of the sensing signal comprises a linear chirp.

In an exemplary implementation, the first frame comprises a communication signal having a single-carrier structure.

For example, the second frame comprises a communication signal having a multi-carrier structure.

In an exemplary implementation, in the obtaining of the estimation the processing circuitry is further configured to: transmit a sensing signal having the first waveform to said second wireless communication device, and receive a feedback signal from said second wireless communication device.

For example, in the obtaining of the estimation the processing circuitry is further configured to perform the estimation according to the feedback signal.

In an exemplary implementation, the feedback signal comprises range information and/or velocity information.

According to an embodiment, a wireless communication device is provided for receiving a sensing signal, comprising: processing circuitry configured to obtain an estimation of a mobility of the wireless communication device; receive a frame including a sensing signal; identify the sensing signal based on a first reference waveform, if the estimation fulfills a condition; or identify the sensing signal based on a second reference waveform, if the estimation does not fulfill the condition; and perform a synchronization and/or channel estimation using the identified sensing signal.

For example, the condition is based on a velocity of the wireless communication device.

In an exemplary implementation, the first reference waveform of the sensing signal comprises one or more non-linear chirps.

For example, at least one of the one or more non-linear chirps is a hyperbolic chirp.

In an exemplary implementation, a first non-linear chirp out of the one or more non-linear chirps has an increasing frequency and a second non-linear chirp out of the one or more non-linear chirps has a decreasing frequency.

For example, the second reference waveform of the sensing signal is a linear chirp.

In an exemplary implementation, in the obtaining of the estimation the processing circuitry is further configured to: receive a sensing signal, identify the received sensing signal based on the first reference waveform, and obtain an estimation of a range and/or a velocity of the wireless communication device based on the identification.

For example, in the obtaining of the estimation the processing circuitry is further configured to: transmit information on the estimation of the range and/or the velocity.

In an exemplary implementation, the processing circuitry is further configured to: reconstruct the received frame based on the identification of the sensing signal comprised in the received frame, subtract the sensing signal from the frame, and obtain a communication signal comprised in the frame.

For example, the obtained communication signal has a single-carrier structure, if the estimation fulfills the condition, and the obtained communication signal has a multi-carrier structure, if the estimation does not fulfill the condition.

Moreover, the corresponding methods are provided comprising steps performed by any of the above-mentioned processing circuitry implementations.

Still further, a computer program is provided, stored on a non-transitory medium, and comprising code instructions which when executed by a computer or by a processing circuitry, performs steps of any of the above-mentioned methods.

According to some embodiments, the processing circuitry and/or the transceiver is embedded in an integrated circuit, IC.

Any of the apparatuses of the present disclosure may be embodied on an integrated chip.

Any of the above-mentioned embodiments and exemplary implementations may be combined.

Although the disclosed subject matter has been described in detail for the purpose of illustration based on what is currently considered to be the most practical and preferred embodiments, it is to be understood that such detail is solely for that purpose and that the disclosed subject matter is not limited to the disclosed embodiments, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

1. A method for transmitting a sensing signal, comprising:
obtaining an estimation of a mobility of a wireless communication device; and
if a condition based on the estimation is fulfilled, transmitting a first frame comprising a sensing signal having a first waveform to said wireless communication device; or
if the condition based on the estimation is not fulfilled, transmitting a second frame comprising a sensing signal having a second waveform different from the first waveform to said wireless communication device.

2. The method according to claim 1, wherein the condition is based on a velocity of the wireless communication device.

3. The method according to claim 1, wherein the first waveform of the sensing signal comprises a one or more non-linear chirps.

4. The method according to claim 3, wherein at least one of the one or more non-linear chirps comprises a hyperbolic chirp.

5. The method according to claim 3, wherein a first non-linear chirp of the one or more non-linear chirps has an increasing frequency and a second non-linear chirp of the one or more non-linear chirps has a decreasing frequency.

6. The method according to any claim 1, wherein the second waveform of the sensing signal comprises a linear chirp.

7. The method according to claim 1, wherein the first frame comprises a communication signal having a single-carrier structure.

8. The method according to claim 1, wherein the second frame comprises a communication signal comprising a multi-carrier structure.

9. The method according to claim 1, wherein obtaining the estimation comprises:
transmitting a sensing signal having the first waveform to said wireless communication device, and
receiving a feedback signal from said wireless communication device.

10. The method according to claim 9, wherein obtaining the estimation further comprises performing the estimation according to the feedback signal.

11. The method according to claim 10, wherein the feedback signal comprises range information and/or velocity information.

12. A method for receiving a sensing signal by a wireless communication device, the method comprising:
obtaining an estimation of a mobility of the wireless communication device;
receiving a frame comprising a sensing signal;
identifying the sensing signal based on a first reference waveform, if the estimation fulfills a condition;
identifying the sensing signal based on a second reference waveform, if the estimation does not fulfill the condition; and
performing a synchronization and/or channel estimation using the identified sensing signal.

13-17. (canceled)

18. The method according to claim 12, wherein obtaining the estimation comprises:
receiving a sensing signal,
identifying the received sensing signal based on the first reference waveform, and
obtaining an estimation of a range and/or a velocity of the wireless communication device based on the identification.

19. The method according to claim 13, wherein obtaining the estimation further comprises:
transmitting information on the estimation of the range and/or the velocity.

20. The method according to claim 12, further comprising:
reconstructing the received frame based on the identification of the sensing signal comprised in the received frame;
subtracting the sensing signal from the frame; and
obtaining a communication signal included comprised in the frame.

21. The method according to claim 20, wherein the obtained communication signal has a single-carrier structure, if the estimation fulfills the condition, and
the obtained communication signal has a multi-carrier structure, if the estimation does not fulfill the condition.

22. At least one non-transitory, computer-readable medium comprising program instructions that, when executed by at least one processor, cause the at least one processor to perform the method of claim 1.

23. A wireless communication device for transmitting a sensing signal, comprising:
processing circuitry configured to
obtain an estimation of a mobility of a second wireless communication device; and
if a condition based on the estimation is fulfilled, transmit a first frame comprising a sensing signal having a first waveform to said second wireless communication device; or
if the condition based on the estimation is not fulfilled, transmit a second frame comprising a sensing signal having a second waveform different from the first waveform to said second wireless communication device.

24-33. (canceled)

34. A wireless communication device for receiving a sensing signal, comprising:
processing circuitry configured to
obtain an estimation of a mobility of the wireless communication device;
receive a frame comprising a sensing signal;
identify the sensing signal based on a first reference waveform, if the estimation fulfills a condition; or
identify the sensing signal based on a second reference waveform, if the estimation does not fulfill the condition; and
perform a synchronization and/or channel estimation using the identified sensing signal.

35-43. (canceled)
